(19) United States
(12) Patent Application Publication
(10) Pub. No.: US 2003/0061221 A1
(43) Pub. Date: Mar. 27, 2003

(54) DOCUMENT PROCESSING METHOD SYSTEM AND STORAGE MEDIUM FOR DOCUMENT PROCESSING PROGRAMS

(76) Inventors: FUMIAKI ITO, KANAGAWA-KEN (JP); YUJI IKEDA, KANAGAWA-KEN (JP); TAKAYA UEDA, KANAGAWA-KEN (JP); SHOGO SHIBATA, KANAGAWA-KEN (JP); NORIKO OHTANI, KANAGAWA-KEN (JP)

Correspondence Address: FITZPATRICK CELLA HARPER & SCINTO, 30 ROCKEFELLER PLAZA, NEW YORK, NY, 10112, US

(21) Appl. No.: 08/863,047

(22) Filed: May 23, 1997

(30) Foreign Application Priority Data
May 24, 1996 (JP) 8-129899
Sep. 3, 1996 (JP) 8-232969

(51) Int. Cl. G06F 7/00

(52) U.S. Cl. 707/100

(57) ABSTRACT

Sequentially input new document information is sorted and retained in a proper folder to facilitate search and retrieval of a desired document to follow. To this end, a list of proper candidate folders is presented to a user to support user saving works. Discrimination between proper folders is made precise by using a search condition, to thereby make search of a desired document easy and reliable.

### BACKGROUND OF THE INVENTION

1. Field of the Invention

The present invention relates to searching desired information from a plurality of sets of information.

The present invention also relates to sorting information into specific types and holding it for the management of a plurality set of information.

The present invention also relates to collecting electronic documents used for electronic newspapers, electronic publishing, electronic circulars and the like and to managing collected documents.

2. Related Background Art

Conventional document processing systems enumerate newly arrived documents which a user peruses and collects necessary documents. As a storage device for collected documents, a folder is used. A user selects one of enumerated folders to store the collected document therein. In using stored documents, a user selects the folder storing a desired document and accesses the desired document. Folders are structured hierarchically so that a user can search documents easily.

In using such a document processing system, documents belonging to the same field as viewed from a user specific point are stored in the same folder. In using stored documents, a user selects a desired folder from the specific viewpoint to obtain a desired document.

Other document processing systems which manage documents without using folders are database management systems which search a document by using document attributes, information retrieval systems which search a document by using document keywords, full text retrieval systems which search a document by using search words from the text of the document, and other systems.

The above-described conventional systems are, however, associated with some problems of lower efficiencies of document collection and use because it is difficult to find a desired folder for document collection and use. This problem occurs when a number of folders are used. It is difficult to find a proper folder from a list of a plurality of enumerated folders. This problem can be solved more or less by hierarchically holding folders. However, a user specific viewpoint for documents often changes with time so that the hierarchical structure formed in the past may mismatch the present user specific viewpoint. Therefore, it becomes difficult to trace the hierarchical structure and find a desired folder. In another case, if a long time elapses after a folder is used, a user often forgets information about that folder or the presence of the folder itself. Also in this case, it is difficult to find the folder. As it becomes difficult to find a proper folder, the number of folders in which a collected document is stored may become small, the collected document may be stored in an improper folder, the collected document may be stored less in a plurality of folders, or the collected document may not be stored. In such cases, the folder cannot reflect correctly the user specific viewpoint), and it becomes difficult to find a desired document from folders.

For the management of documents by using database management systems or information retrieval systems, it is necessary to provide documents with attributes or keywords each time documents are collected so that a load of collection work becomes high. A high load of collection work poses significant problems because such document processing systems are used daily by individual persons.

Document search from user specific viewpoints is therefore difficult in the case of database management systems and information retrieval systems using only attributes and keywords assigned to documents and in the case of document management using full text retrieval systems.

### SUMMARY OF THE INVENTION

It is an object of the present invention to manage documents from specific user viewpoints and facilitate proper document collection and use.

It is another object of the invention to facilitate selection of a proper set of information in which newly input information is held.

It is another object of the present invention to facilitate searching information which matches desired search conditions.

It is another object of the present invention to make coincidence judgment of search conditions more proper.

### BRIEF DESCRIPTION OF THE DRAWINGS

FIG. 1 is a block diagram showing an example of the functional structure for information collection and search.

FIG. 2 is a diagram showing a hardware structure of a document processing system of this invention.

FIG. 3 is a flow chart illustrating the outline of a candidate folder search process of this invention.

FIG. 4 is a flow chart illustrating the outline of a document retaining process of this invention.

FIG. 5 is a flow chart illustrating the outline of a folder search process of the invention.

FIG. 6 is a block diagram showing an example of the functional structure for information collection.

FIG. 7 is a block diagram showing an example of the functional structure for information search.

FIG. 8 is a block diagram showing an example of a functional structure for sorting a plurality piece of information into one specific type.

FIG. 9 is a flow chart illustrating a document sorting process used for the functional structure shown in FIG. 8.

FIG. 10 is a block diagram showing another example of the functional structure for information collection and search.

FIG. 11 is a block diagram showing a functional structure for the calculation of a search score.

FIG. 12 is a flow chart illustrating the outline of a search score calculating process.

FIG. 13 is a diagram showing an example of a document set retainer.

FIG. 14 is a flow chart illustrating a second example of the outline of the search score calculating process.

FIG. 15 is a diagram showing a second example of the document set retainer.

FIG. 16 is a diagram illustrating a load state of control programs of the invention into a computer.

### DETAILED DESCRIPTION OF THE PREFERRED EMBODIMENTS

Embodiments of the invention will be described in detail with reference to the accompanying drawings.

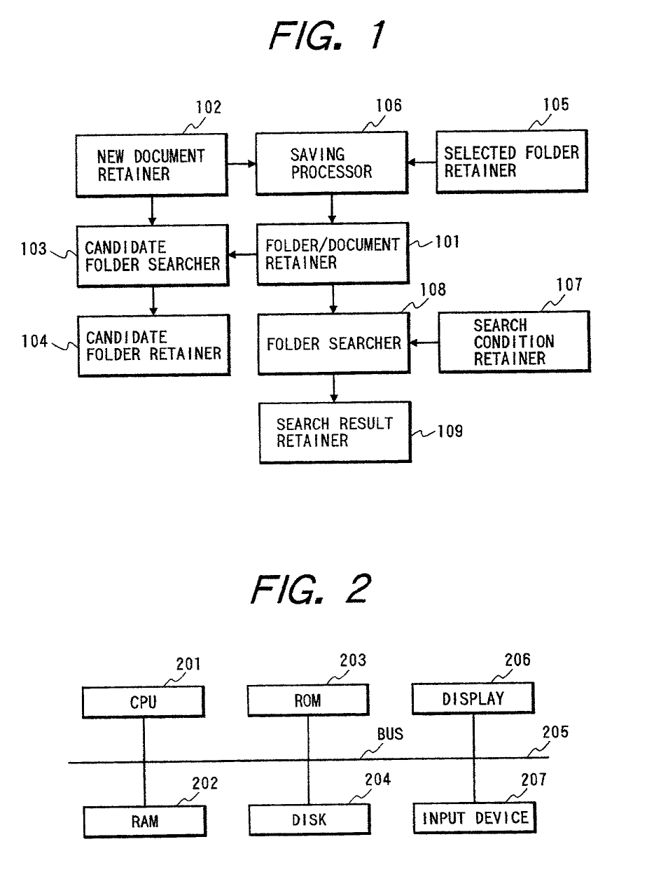

FIG. 1 is a block diagram showing the functional structure for information collection and search of this invention.

In FIG. 1, reference numeral 101 represents a folder/document retainer for retaining folders and documents belonging to each folder. Reference numeral 102 represents a new document retainer for retaining a newly arrived document. Reference numeral 103 represents a candidate folder searcher for searching a candidate folder suitable for retaining the document retained by the new document retainer 102. Reference numeral 104 represents a candidate folder retainer for retaining a candidate folder searched by the candidate folder searcher 103. Reference numeral 105 represents a selected folder retainer for retaining the folder selected by a user from candidate folders retained by the candidate folder retainer 104. Reference numeral 106 represents a saving processor for controlling the folder/document retainer 101 to retain the document retained by the new document retainer 102 in the selected folder retained by the selected folder retainer 105. Reference numeral 107 represents a search condition retainer for retaining search conditions of each folder. Reference numeral 108 represents a folder searcher for searching folders retained in the folder/document retainer 101 in accordance with the search condition retained by the search condition retainer 107. Reference numeral 109 represents a search result retainer for retaining the folder searched by the folder searcher 108.

FIG. 2 is a diagram showing the hardware structure of a document processing system of this invention. In FIG. 2, reference numeral 202 represents a CPU which operates in accordance with programs stored in a ROM 203.

Reference numeral 202 represents a RAM which provides storage areas necessary for the operations of the new document retainer 102, candidate folder retainer 104, selected folder retainer 105, search condition retainer 107, search result retainer 109, and the above-described programs. The programs stored in ROM 203 executes procedures illustrated in the flow charts to be described later. Reference numeral 104 represents a disk drive which realizes the folder/document retainer 101. Reference numeral 205 represents a bus. Reference numeral 206 represents a display such as a CRT and a liquid crystal display for displaying characters, images and the like. Reference numeral 207 represents an input device such as a keyboard and a pointing device.

In this example, the folder/document retainer 101 stores a list of documents and a list of folders. A document d is given by:

d=(t, v(d))

where t is text data of a document, and v(d) is vector data representing the feature of a text t related to a vector space model. A folder f is given by:

f=(1, D, v(f))

where 1 is label data represented by a character string by which a user visually confirms a folder. This character string may be input from the input device 207 by a user or may be automatically allocated. The data D represents a set of documents retained in a folder and may represent an empty folder. The data v(f) is vector data (dεD) which is an average of vectors v(d) of all documents d retained in a folder f. The number of folders retained in the folder/document retainer 101 is represented by N. The new document retainer 102 retains one document. The candidate folder retainer 104, selected folder retainer 105, and search result retainer 109 each have a list of folder numbers. The search condition retainer 107 retains search words and search equations representing logical relationship between search words.

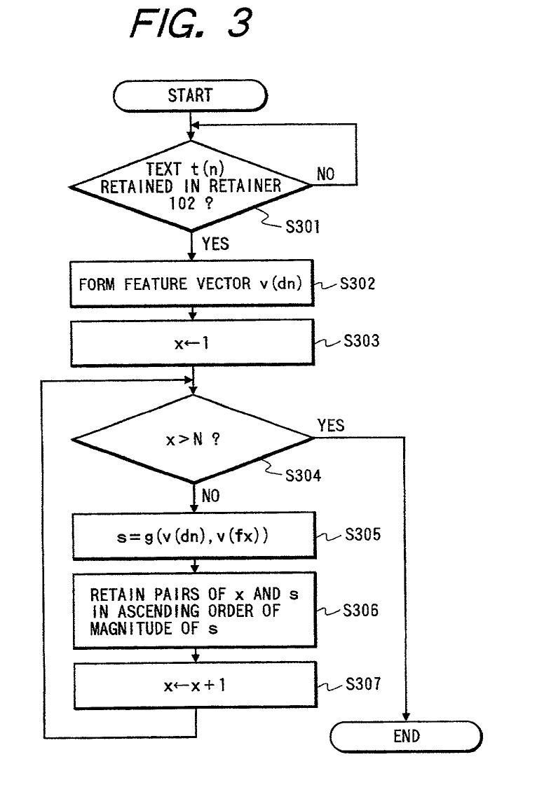

With reference to the flow chart shown in FIG. 3, the operation of a candidate folder search process of the document processing system of the invention will be described.

At Step S301 it is checked whether the new document retainer 102 has retained the text t(n) of a newly arrived document. If retained, the flow advances to Step S302, whereas if not, Step S301 is repeated until the new document retainer 102 retains the text t(n) of a new document. The text t(n) of a new document arrives at the new document retainer 102 at a timing of an input instruction by a user or at a timing of automatic supply of a text from a text supplier.

At Step S302 a feature vector v(dn) of the text t(n) is generated, this feature vector and the text t(n) being retained by the new document retainer 102. Thereafter, the flow advances to Step S303.

At Step S303 the value x of a counter is initialized to 1. The counter is used for counting a folder number and sequentially accessing folder information retained by the folder/document retainer 101. Thereafter, the flow advances to Step S304.

At Step S304 the value x of the counter is compared with the number N of folders retained in the folder/document retainer 101 in order to judge whether the processes of Steps S305 to S307 have been executed for all folders retained by the folder/document retainer 101. If x≦N, the flow advances to Step S305, whereas if x>N, the candidate folder search process illustrated in the flow chart of FIG. 3 is terminated.

At Step S305 a score S=g(v(dn), v(fx)) is calculated where f(x) is the x-th folder retained by the folder/document retainer 101 and d(n) is a new document. The function g is used for determining a similarity of documentary features between the new document d(n) and the folder f(x). The smaller this score, the more similar the features of the new document d(n) are so that the folder is suitable for retaining the new document. The function q is given by:

g(v(1), v(2))=(v(1)·v(2))/(|v(1)||v(2)|)

After the score is calculated, the flow advances to Step S306.

At Step S306 the candidate folder retainer 104 retains the score S calculated at Step S305 and the corresponding folder number x in an ascending order of values of S. Thereafter, the flow advances to Step S307.

At Step S307 the value x of the counter is incremented by 1 and thereafter the flow returns to Step S304.

Information (folder label and the like) regarding the candidate folder obtained by the candidate folder search process described with reference to the flow chart of FIG. 3 and retained in the candidate folder retainer 104, is displayed on the display 206 in correspondence with the document retained by the new document retainer 102, to thereby notify the candidate folder to the user.

Folders displayed on the display 206 in the retained order (ascending order of score S) may include all folders retained by the candidate folder retainer 104 or only upper level folders selected in accordance with the score S and the number N.

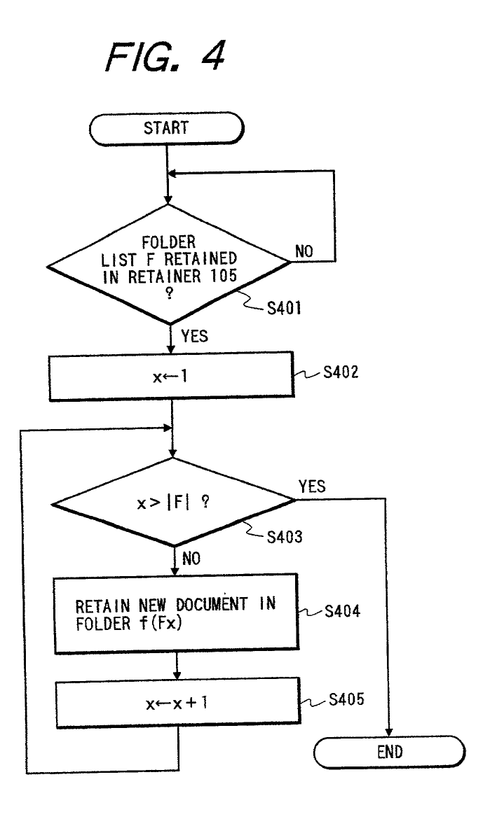

Next, with reference to the flow chart shown in FIG. 4, the operation of a document retaining process of the document processing system of this invention will be described.

At Step S401 it is checked whether the selected folder retainer 105 has retained a folder list F. If retained, the flow advances to Step S402, whereas if not, Step S401 is repeated until the selected document retainer 105 retains the list F. This list F is a train of folders input by the user from the input device 207 such as a keyboard. The list F is input while considering candidate folder information supplied from the candidate folder retainer 104.

At Step S402 the value x of a counter is initialized to 1, the counter being used for indicating the sequential order of the accessing folder in the list F. Thereafter, the flow advances to Step S403.

At Step S403, the value x of the counter is compared with the number |F| of folders. If x≦|F|, the flow advances to Step S404, whereas if x>|F|, the document retaining process illustrated in the flow chart of FIG. 4 is terminated.

At Step S404, the new document d(n) is added to a document list D(Fx) corresponding to the x-th folder f(Fx) in the selected folder retainer 105. For the new D(Fx) added with d(n), a new vector v(f(Fx)) is calculated which is an average of vectors v(d) (d εD(Fx)). Thereafter, the flow advances to Step S405.

At Step S405, the value x of the counter is incremented by 1 and thereafter the flow returns to Step S403.

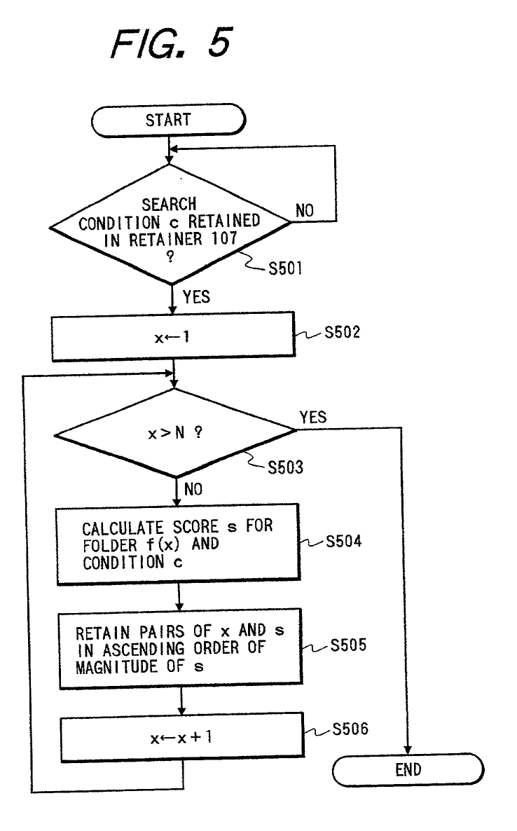

Next, with reference to the flow chart shown in FIG. 5, the operation of a folder search process of the document processing system of this invention will be described.

At Step S501 it is checked whether the search condition retainer 107 has retained a search condition c. If retained, the flow advances to Step S502, whereas if not, Step S501 is repeated until the search condition retainer 107 retains the search condition c. The search condition c is a train of words or sentences input by the user from the input device 207 such as a keyboard.

At Step S502 the value x of a counter is set to a default value 1, the counter being used for indicating the sequential order of the accessing folder among all folders retained in the folder/document retainer 101. Thereafter, the flow advances to Step S503.

At Step S503, the value x of the counter is compared with the total number N of folders retained by the folder/document retainer 101. If x≦N, the flow advances to Step S504, whereas if x>N, the folder search process illustrated in the flow chart of FIG. 5 is terminated.

At Step S504 a score S for the x-th folder f(x) in the folder/document retainer 101 and for the search condition c is calculated by the following equation:

$$S = \frac{{\sum }^{d ∈ D ( x )} f ( c , d )}{\vert D ( x ) \vert}$$

The function f is used for judging through pattern matching whether the document contains the search words c. If the document contains the search words c, f(c, d)=1, whereas if it does not contain, f(c, d)=0. This judgement is performed for all documents D(x) of the x-th folder. Therefore, the score S is the number of x-th folder documents containing the search words divided by the total number |D(x)| of documents, and shows a ratio of documents satisfying the search condition to all documents in the x-th folder.

After the score is calculated at Step S504, the flow advances to Step S505.

At Step S505, the search result retainer 109 retains the score S calculated at Step s504 and the corresponding folder number x in an ascending order of values of S. Thereafter, the flow advances to Step S506.

At Step S506 the value x of the counter is incremented by 1 and thereafter the flow returns to Step S503.

Information (folder label and the like) regarding the candidate folder obtained by the folder search process described with reference to the flow chart of FIG. 5 and retained in the search result retainer 109, is displayed on the display 206 in correspondence with the search words c, to thereby notify the candidate folder to the user. Folders displayed on the display 206 in the retained order (ascending order of score S) may include all folders retained by the search result retainer 109 or only upper level folders selected in accordance with the score S and the number N.

During document collection performed by the document processing system of this invention, a folder most suitable for retaining a new document is retained at the top of the candidate folder retainer 104.

A user can select the candidate folder easily, by looking at the folder labels near the top thereof retained by the candidate folder retainer 104. The number of folders having documents matching the search condition designated by the user can be reduced and the document search can be performed efficiently.

Use of the document processing system of this invention allows a user to retain documents from a user specific viewpoint and to easily collect and search documents.

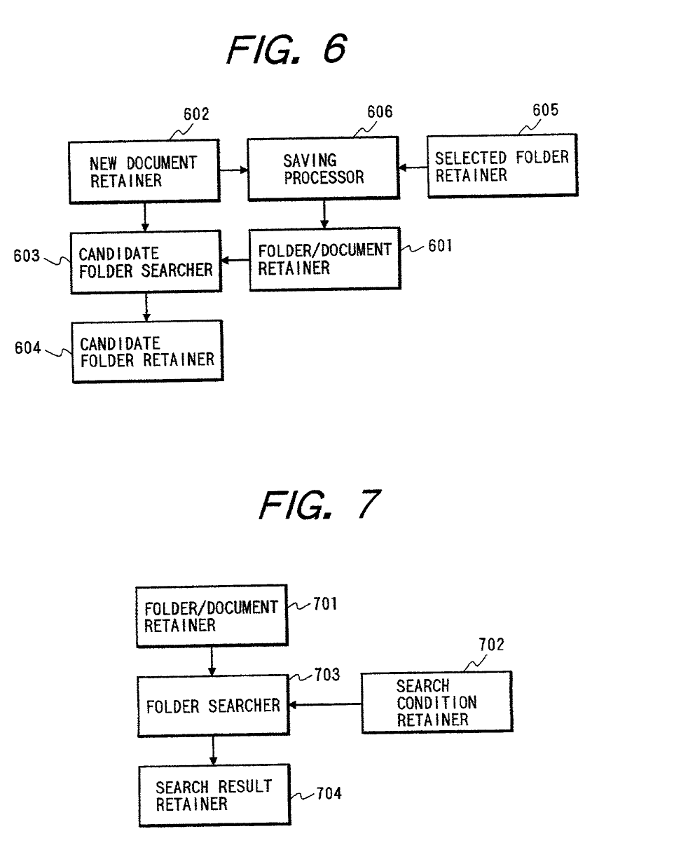

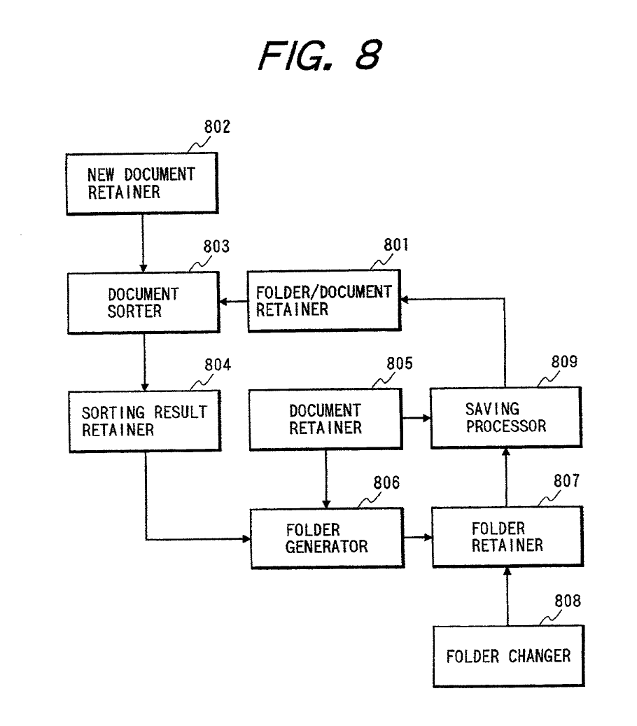

In the above example, the function of facilitating both document collection and search is realized. The invention is not limited to this, but a function of facilitating either document collection or document search may also be realized. This example is illustrated in the block diagrams of FIGS. 6 and 7. As apparent from the comparison with the functional structure shown in FIG. 1, the functional structures 601 to 607 shown in FIG. 6 correspond to the functional structures 101 to 107 shown in FIG. 1, and the functional structures 701 to 704 shown in FIG. 7 correspond to the functional structures 101, 107, 108 and 109 shown in FIG. 1.

In the example shown in FIG. 1, the candidate folder for each document is searched and displayed to facilitate document collection. The invention is not limited thereto. In another example, a newly arrived document is sorted into a particular folder suitable for the document and the sorting result or folder is displayed to facilitate document collection. This example will be described with reference to the functional structure shown in FIG. 8.

In FIG. 8, reference numeral 801 represents a folder/document retainer for retaining folders and documents belonging to each folder. Reference numeral 802 represents a new document retainer for retaining a newly arrived document. Reference numeral 803 represents a document sorter for sorting the document retained by the new document retainer 802 into a particular folder suitable for the document. Reference numeral 804 represents a sorting result retainer for retaining the result sorted by the document sorter 803. Reference numeral 805 represents a document retainer for retaining a document to be saved. Reference numeral 806 represents a folder generator for generating a folder for a document retained by the document retainer in accordance with the sorting result retained by the sorting result retainer 804. Reference numeral 807 represents a folder retainer for retaining the folder generated by the folder generator 806. Reference numeral 808 represents a folder changer for changing the folder retained by the folder retainer 807. Reference numeral 809 represents a saving processor for controlling the folder/document retainer 801 to retain the document retained by the document retainer 805 in the folder retained by the folder retainer 807.

In this example, the sorting result retainer 804 stores a list of documents sorted for each folder f. The document retainer 805 retains one document before it is saved. The folder/document retainer 801, new document retainer 802, and folder retainer 803 have the same structures as those of the retainers 101, 102 and 105 described with FIG. 1.

The structure for performing each function of the system shown in FIG. 8 is the same as described with FIG. 2, and the description thereof is omitted.

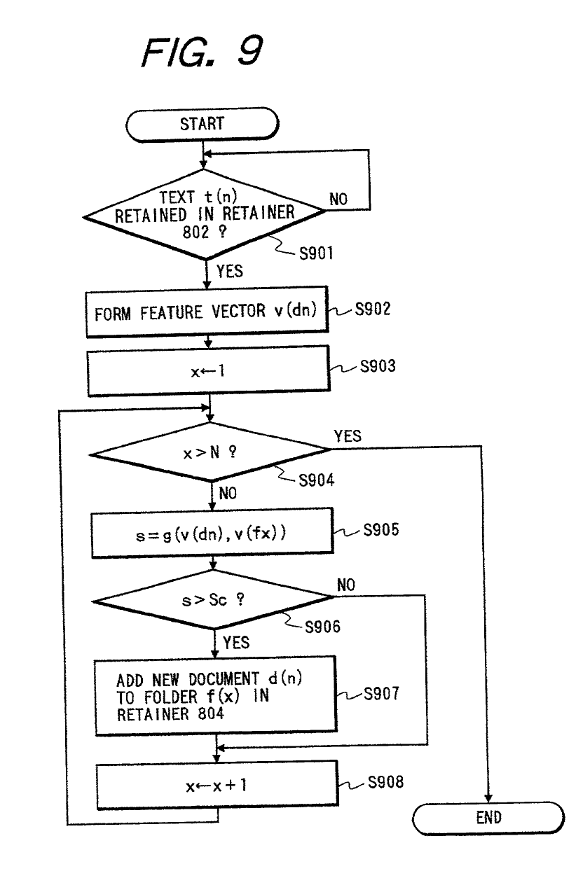

With reference to the flow chart shown in FIG. 9, the operation of a document sorting process to be executed by each function shown in FIG. 8 will be described.

At Step S901 it is checked whether the new document retainer 802 has retained the text t(n) of a newly arrived document. If retained, the flow advances to Step S902, whereas if not, Step S901 is repeated until the new document retainer 802 retains the text t(n) of a new document.

At Step S902 a feature vector v(dn) of the text t(n) is generated, this feature vector and the text t(n) being retained by the new document retainer 802. Thereafter, the flow advances to Step S903.

At Step S903 the value x of a counter is initialized to 1. The counter is used for counting a folder number and sequentially accessing folder information retained by the folder/document retainer 801. Thereafter, the flow advances to Step S904.

At Step S904 the value x of the counter is compared with the number N of folders retained in the folder/document retainer 801. If x≦N, the flow advances to Step S905, whereas if x>N, the process is terminated.

At Step S905 a score S=g(v(dn), v(fx)) is calculated where f(x) is the x-th folder retained by the folder/document retainer 801 and d(n) is a new document. After the score is calculated, the flow advances to Step S906.

At Step S906 the score S calculated at Step S905 is compared with a preset threshold value Sc. If S>Sc, the flow advances to Step S907, whereas if S≦Sc, the flow advances to Step S908.

At Step S907, the new document d(n) is added to the set of documents corresponding to the folder f(x) retained in the sorting result retainer 804.

At Step S908 the value x of the counter is incremented by 1 and thereafter the flow returns to Step S904.

In a folder generating process, the folder retainer 807 retains all folders associated with the sorting result retainer 804 to which documents retained by the document retainer 808 belong. In a folder changing process, a user adds a folder to, or deletes a folder from, the folder list retained by the folder retainer 807. The saving process is the same as that shown in the flow chart of FIG. 4.

With the above processes, during document collection, the document to be saved is sorted into a particular folder which is in turn retained by the sorting result retainer 804. Documents in the folder sorted and retained by the sorting result retainer are searched by a user. The user can therefore search the whole body of relevant documents from a user specific viewpoint. The saving process may be performed only upon reception of a save instruction if the folder retainer 807 retains a default folder and a change instruction is not input from the input device 207. As above, use of the document processing system of this invention allows a user to search documents and obtain a suitable folder from a user specific viewpoint so that document collection becomes easy.

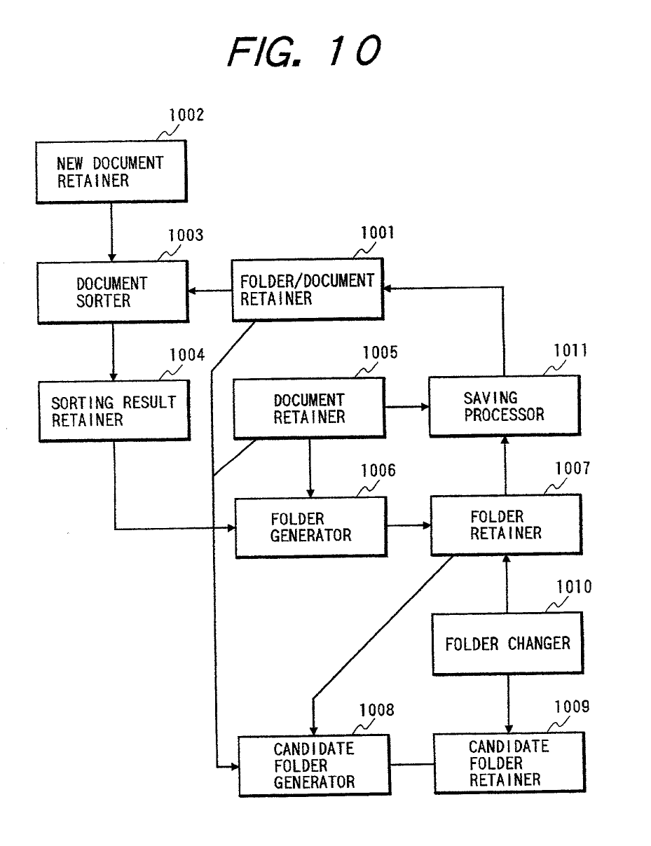

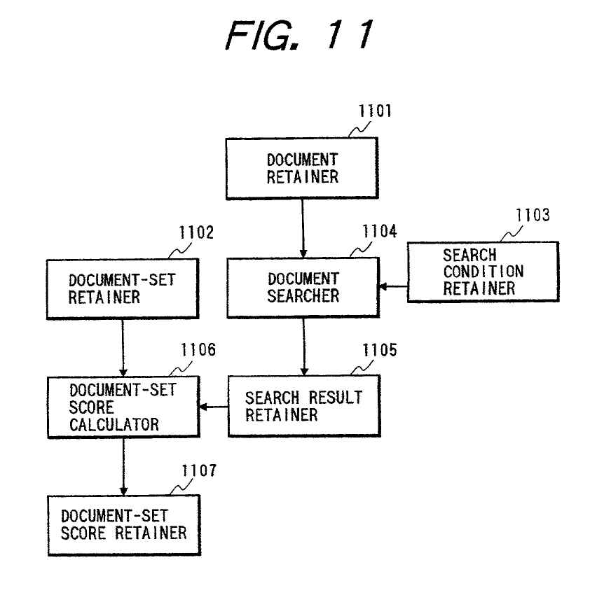

In the above example, a proper folder is generated in accordance with the sorting result, and a user checks this folder and, if necessary, changes it. The invention is not limited to this, but the folder may be changed while checking the candidate folder determined by the candidate folder forming process shown in FIG. 1 to facilitate document collection. This example will be described with reference to the functional structure shown in FIG. 10.

In FIG. 10, reference numeral 1001 represents a folder/document retainer for retaining folders and documents belonging to each folder. Reference numeral 1002 represents a new document retainer for retaining a newly arrived document. Reference numeral 1003 represents a document sorter for sorting the document retained by the new document retainer 1002 into a particular folder suitable for the document. Reference numeral 1004 represents a sorting result retainer for retaining the result sorted by the document sorter 1003. Reference numeral 1005 represents a document retainer for retaining a document to be saved. Reference numeral 1006 represents a folder generator for generating a folder for a document retained by the document retainer in accordance with the sorting result retained by the sorting result retainer 1004. Reference numeral 1007 represents a folder retainer for retaining the folder generated by the folder generator 1006. Reference numeral 1008 represents a candidate folder generator for generating as a candidate folder a folder suitable for a document retained by the document retainer 1005, excepting the folder retained by the folder retainer 1007. Reference numeral 1009 represents a candidate folder retainer for retaining the candidate folder generated by the candidate folder generator 1008. Reference numeral 1010 represents a folder changer for changing the folder retained by the folder retainer 1007 and the candidate folder retained by the candidate folder retainer 1009. Reference numeral 1011 represents a saving processor for controlling the folder/document retainer 1001 to retain the document retained by the document retainer 1005 in the folder retained by the folder retainer 1007.

In this example, the folder/document retainer 1001, new document retainer 1002, sorting result retainer 1004, and folder retainer 1007 have the same structures as the structures 901, 902, 904, and 907 shown in FIG. 9. The candidate folder retainer 1008 has the same structure as the structure 104 shown in FIG. 1. Each process is also the same as that described earlier. However, the folder changing process is partially different. In the folder changing process of this example, the folder deleted from the folder retainer 1007 is retained by the candidate folder retainer 1009. If the candidate folder retained by the candidate folder retainer 1009 is added to the folder retainer 1007, this candidate folder is deleted from the candidate folder retainer 1009.

With the above processes, in changing the sorting result and determining a final folder, an additional folder can be easily found so that document collection becomes easier.

In the examples described above, the score is calculated by using distance relationship between feature vectors in the candidate folder search process and document sorting process. The invention is not limited only to this, but other methods may be used for the calculation of a score which indicates a degree of possibility of a document belonging to the folder. For example, a search condition c composed of a user keyword and its logical relationship may be added to the folder data to use:

f=(l, D, c, v(f)),

and calculate a score S=f(c(x), d(n)). The score may also be calculated as:

S=f(c(x), d(n))×C+g(v(fx), v(dn))

where C is a constant.

The invention is not limited only to the folder search process using the search condition c composed of a user keyword and its logical relationship. Other methods of searching a folder may be used. For example, another folder f(t) similar to a folder to be actually searched may be used as the search condition to calculate the score S=g(v(fx), v(ft)). Alternatively, a document d(t) having similar contents to a folder to be actually searched may be used as the search condition to calculate the score S=g(v(fx), v(dt)).

In the above example, only the folder searcher is used for searching a folder. The invention is not limited thereto, but a document searcher for searching a document may be used.

In the above example, the document sorter sorts a document into specific one of all folders. The invention is not limited thereto, but a document may be sorted into specific one of limited folders. For example, folders designated by a user may be used, or folders used in a predetermined past time period may be used.

In the above example, the score is calculated by the same method for all folders and compared with the same threshold value in the document sorting process. The invention is not limited thereto, but the score calculation method may be changed for each folder or the threshold value may be changed for each folder.

In the above example, the candidate folder search process and folder search process retain all final folders as the search result. The invention is not limited thereto, but only some folders may be retained as the search result. For example, folders whose scores are in excess of a preset threshold value may be retained, or folders whose scores are in a preset range of values or rates may be retained.

In the above example, when a document is collected, a new folder is not generated. The invention is not limited thereto, but a new folder generator may be provided which generates a new folder and adds it to the folder retainer.

In the above embodiment, the sorting result is always retained in the sorting result retainer. The invention is not limited thereto, but a sorting result deleting unit may be provided which deletes the sorting result after the document is saved or which deletes the sorting result of only a particular folder.

In the above example, the value of the function f is calculated for documents stored in a plurality of folders in the folder search process. The invention is not limited thereto, but the value of the function f may be calculated only once for one document. For example, the value of the function f calculated once may be stored, or after the value of the function f is calculated for a document, the calculated value is sent to the folder to which the document belongs and the score received folder by folder is synthesized to derive the folder score.

In the above example, the value of the function f is calculated through pattern matching. The invention is not limited thereto, but an index for a document may be generated to calculate the value of the function f by using this index.

A different example of the judgement of coincidence between the search condition and the folder to be executed by the folder searcher 108 of FIG. 1 will be described. The term “document set” used in FIG. 11 and in the description of the specification corresponds to the term “folder” used in FIG. 1 and in the description of the specification.

In FIG. 11, reference numeral 1101 represents a document retainer for retaining documents to be searched. Reference numeral 1102 represents a document set retainer for retaining a set of documents. Reference numeral 1103 represents a search condition retainer for retaining a search condition. Reference numeral 1104 represents a document searcher for searching a document satisfying the search condition retained by the search condition retainer 1103. Reference numeral 1105 represents a search result retainer for retaining a search result of the document searcher 1104. Reference numeral 1106 represents a document set score calculator for calculating a score of each document set retained by the document set retainer 1102 by using the search result retained by the search result retainer 1105. Reference numeral 1107 represents a document set score retainer for retaining a score calculated by the document set score calculator 1106.

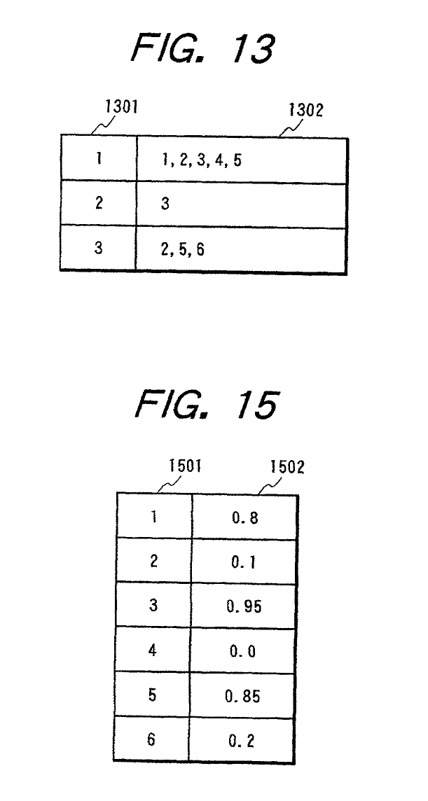

In this example, the document set retainer 1102 stores a list of document numbers of a document set added with a set number specific to each document set. An example of the document set retainer is shown in FIG. 13. A column 1301 stores identification set numbers added to respective document sets, and a column 1302 stores lists of document identification numbers.

The document retainer 1101 stores the text of each document added with a document number specific to the document. The search condition retainer 1103 stores a list of search words. The search result retainer 1105 stores a list of document numbers. The document set score retainer 1107 stores the score of each document set identified by the set number.

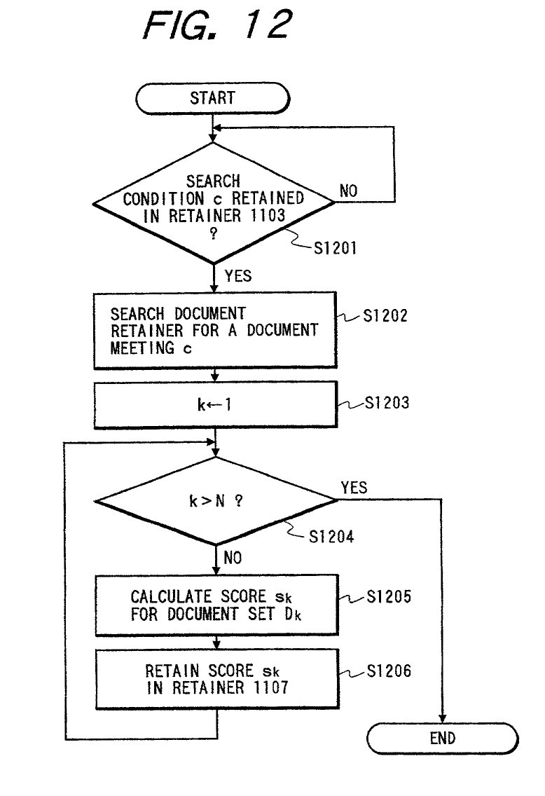

With reference to the flow chart shown in FIG. 12, the operation of the search process will be described.

At Step S1201 it is checked whether the search condition retainer 1103 has retained a search condition c constituted of a list of search words. If retained, the flow advances to Step S1202, whereas if not, Step S1201 is repeated.

At Step S1202 documents satisfying the search condition c retained by the search condition retainer 1103 are searched from the documents retained by the document retainer 1101. Whether the text of each document contains each word of the search condition c is checked through pattern matching. If the text contains all search words, it is judged that the document satisfies the search condition c. The document number of the document satisfying the search condition is retained by the search result retainer 1105. Thereafter, the flow advances to Step S1203.

At Step S1203 the value k is set to 1. Thereafter, the flow advances to Step S1204.

At Step S1204 the value k is compared with the number N of document sets retained in the document set retainer 1102. If k≦N, the flow advances to Step S1205, whereas if k>N, the process is terminated.

At Step S1205, a score sₖ of the k-th document set Dₖ in the document retainer 1102 is calculated by using an F distribution with a degree of freedom (φ₁, φ₂) by the following equation:

$${s}_{k} = \frac{{φ}_{2}}{{φ}_{1} {F}_{{φ}_{1}}^{{φ}_{2}} ( α ) + {φ}_{2}}$$

where n is the number of documents in the document set Dₖ, x is the number of documents in the search result retainer 1105 among those documents belonging to Dₖ, φ₁ is 2(n−x+1), and φ₂ is 2x. α is a parameter for designating a reliability in interval estimation, for example, α=0.1. The flow thereafter advances to Step S1206.

At Step S1206, the score sₖ calculated at Step S1205 is retained by the document set score retainer 1107. Thereafter, the flow returns to Step 51204.

For example, in the example of the document set retainer shown in FIG. 13, it is assumed that the document number obtained as the search result after Step S1202 is (1, 3, 5). The values n and x of each of the document sets 1 to 3 are n=5 and x=3 for D₁, n=1 and x=1 for D₂, and n=3 and x=1 for D₃. Therefore, the scores sₖ of the document sets are given by:

$${s}_{1} = \frac{6}{6 {F}_{6}^{5} ( 0.1 ) + 6} ≃ 0.25$$

$${s}_{2} = \frac{6}{2 {F}_{2}^{2} ( 0.1 ) + 2} ≃ 0.10$$

$${s}_{3} = \frac{6}{6 {F}_{5}^{2} ( 0.1 ) + 2} ≃ 0.03$$

With the above search method, a high score is given to the document set satisfying the search condition (i.e., a document set containing many documents matching the search condition). Therefore, by using the calculated scores, a user can easily search the document set matching the search condition.

In the above example, the number of elements of a document set and the number of elements of the document set satisfying the search condition are used to perform statistical interval estimation of binomial distribution, and its lower limit value is used as the score of the whole document set.

In the following example, the number of elements of a document set and a score for the search condition for each element are used to perform interval estimation of population mean, and its lower limit value is used as the score of the whole document set.

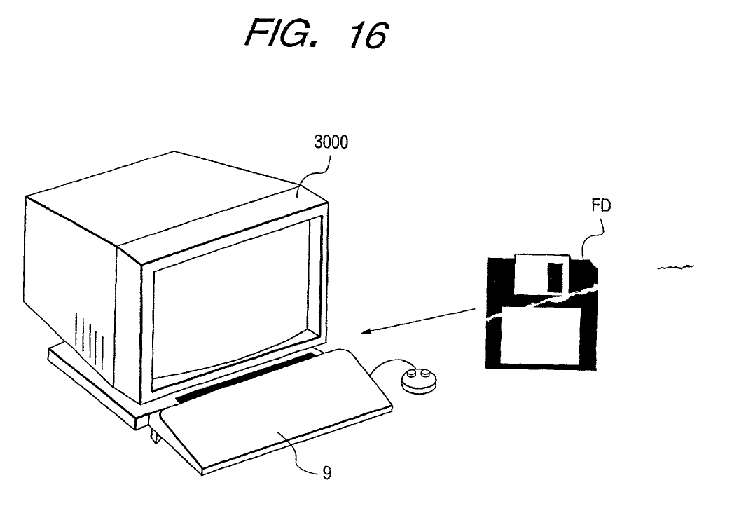

The fundamental structure of this example is the same as that shown in FIG. 11. However, the document searcher 1104 calculates a score for the search condition of each document, and the search result retainer 1105 retains a score of each document. An example of the search result retainer 1105 is shown in FIG. 15. A column 1501 stores document numbers and a column 1502 stores scores of the documents.

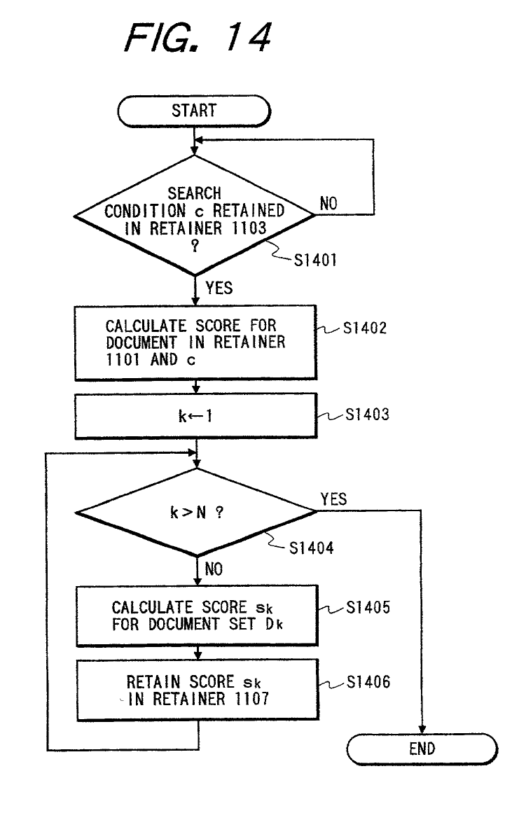

With reference to the flow chart shown in FIG. 14, the operation of the search process will be described.

At Step S1401, it is checked whether the search condition retainer 1103 has retained a search condition c constituted of a list of search words. If retained, the flow advances to Step S1402, whereas if not, Step S1401 is repeated.

At Step S1402, a score for the search condition c retained by the search condition retainer 1103 and for documents retained in the document retainer 1101 is calculated. This score is calculated by using occurrent frequency of each word of the search condition c in the text of each document. The calculated score is retained by the search result retainer 1105. Thereafter, the flow advances to Step S1403.

At Step S1403, the value k is set to 1. Thereafter, the flow advances to Step S1404.

At Step S1404, the value k is compared with the number N of document sets retained in the document set retainer 1102. If k≦N, the flow advances to Step S1405, whereas if k>N, the process is terminated.

At Step S1405, an unbiased estimator V is calculated by the following equation if n>1:

$$V = \frac{\sum {( x - \overline{x} )}^{2}}{n - 1}$$

where n is the number of documents in the k-th document set Dₖ retained in the document set retainer 1102, and x is a mean score of documents belonging to Dₖ. The score sₖ is calculated by using the degree of freedom φ and the t distribution of double side probability α:

$${s}_{k} = \overline{x} - t ( φ , α ) \frac{\sqrt{V}}{\sqrt{n}}$$

The degree of freedom φ is n−1. If n=1, then

sₖ=α\overline{x}

wherein α is a parameter for designating a reliability in interval estimation, for example, α=0.1. The flow thereafter advances to Step S1406.

At Step S1406, the score sₖ calculated at Step S1405 is retained by the document set score retainer 1107. Thereafter, the flow returns to Step S1404.

In the above example, an AND operation is performed among search words of the search condition. The invention is not limited thereto, but optional search conditions for documents may be used such as other logical relationships and search word positions in each document.

In the above examples, document search is performed through pattern matching. The invention is not limited thereto, but other optional search methods may be used. For example, an index may be set to each document to search a document by using the index.

In the above examples, information constituting a set is a document. The invention is not limited thereto, but optional information may be used such as a record which is a set of data. In this case, search methods suitable for respective information are used.

In the above examples, a score is calculated for each set. The invention is not limited thereto, but sets may be retained and the score for the set containing at least one document in the search result may be calculated. The scores of other sets are 0.

In the above examples, scores for all sets are retained. The invention is not limited thereto, but only some scores may be retained. For example, scores in excess of a preset threshold value may be retained or scores in a predetermined range of values and ratios may be retained.

In the above examples, each function is realized on the same computer. The invention is not limited thereto, but each function may be realized on computers and processors distributed on a network.

In the above examples, the search condition retainer, search result retainer, and document set score retainer are realized by a RAM, and the document retainer and document set retainer are realized by a disk. The invention is not limited thereto, but optional storage devices may be used.

In the above examples, programs are stored in ROM. The invention is not limited thereto, but they may be stored in other storage devices or they may be realized by circuits which provide such program functions.

Obviously, the invention may be embodied by supplying a storage medium storing software program codes realizing the functions of the invention to a system or apparatus whose computer (CPU or MPU) runs by reading the program codes stored in the storage medium.

In this case, the software program codes read from the storage medium themselves realize the functions of the invention. Therefore, the storage medium storing the program codes constitutes the invention.

The storage medium storing such program codes may be a floppy disk, a hard disk, an optical disk, a magnetooptical disk, a CD-ROM, a CD-R, a magnetic tape, a non-volatile memory card, and a ROM.

Obviously, such program codes are other types of this invention, not only for the case wherein the functions of the invention are realized by executing the program codes supplied to the computer but also for the case wherein the functions are realized by the program codes part or the whole of which is used with an OS (operating system) on which the computer runs.

Furthermore, the functions of the invention may also be realized by a system wherein in accordance with the program codes stored in a memory of a function expansion board or unit connected to the computer supplied with the program codes, a CPU or the like of the function board or unit executes part or the whole of the actual tasks.

Obviously, the invention is also applicable to the case wherein the software program codes realizing the functions of the invention stored in a storage medium are supplied to a requestor via communication lines such as personal computer communications.

What is claimed is:

1. A document processing system comprising:
document retaining means for retaining a document and a folder to which the document belongs;
candidate folder determining means for determining a candidate folder suitable for retaining new document by comparing the new document with a feature of the folder;
notifying means for notifying the candidate folder determined by said candidate folder determining means; and
updating means for updating the feature of the folder in response to saving the new document in the candidate folder.

2. A document processing system according to claim 1, wherein the feature of the folder is an average of features of documents belonging to the folder.

3. A document processing system according to claim 1, wherein a plurality of candidate folders suitable for saving the new document are determined and a list of a plurality of determined candidate folders is displayed.

4. A document processing system comprising:
judging means for judging a similarity degree between document information and a plurality set of information of documents stored in a folder;
similarity order calculating means for calculating a similarly order of a plurality of folders in accordance with the similarity judged by said judging means; and
notifying means for notifying the similarity order of the plurality of folders calculated by said similarity order calculating means.

5. A document processing system comprising:
retaining means for retaining a plurality of folders each storing a plurality set of document information;
determining means for determining a folder containing a larger amount of document information matching an input search condition; and
notifying means for notifying the folder determined by said determining means.

6. A document processing system according to claim 5, wherein the search condition is a keyword.

7. A document processing system according to claim 6, wherein said determiming means determines the folder on the assumption that a document containing a keyword matching the search condition is coincident.

8. A document processing system according to claim 5, wherein said determining means determines the folder through statistical estimation using the number of information sets of documents belonging to the folder and the number of documents matching the search condition.

9. A document processing method comprising the steps of:
retaining a document and a folder to which the document belongs;
determining a candidate folder suitable for retaining a new document by comparing the new document with a feature of the folder;
notifying the candidate folder determined at said candidate folder determining step; and
updating the feature of the folder in response to saving the new document in the candidate folder.

10. A document processing method comprising the steps of:
judging a similarity degree between document information and a plurality set of information of documents stored in a folder;
calculating a similarly order of a plurality of folders in accordance with the similarity degree judged at said judging step; and
notifying the similarity order of the plurality of folders calculated at said similarity order calculating step.

11. A document processing method comprising the steps of:
retaining a plurality of folders each storing a plurality set of document information;
determining a folder containing a larger amount of document information matching an input search condition; and
notifying the folder determined at said determining step.

12. A computer readable storage medium storing programs executing the steps of:
retaining a document and a folder to which the document belongs;
determining a candidate folder suitable for retaining a new document by comparing the new document with a feature of the folder;
notifying the candidate folder determined at said candidate folder determining step; and
updating the feature of the folder in response to saving the new document in the candidate folder.

13. A computer readable storage medium storing programs executing the steps of:
judging a similarity degree between document information and a plurality set of information of documents stored in a folder;
calculating a similarly order of a plurality of folders in accordance with the similarity degree judged at said judging step; and
notifying the similarity order of the plurality of folders calculated at said similarity order calculating step. 14. A computer readable storage medium storing programs executing the steps of:
retaining a plurality of folders each storing a plurality set of document information;
determining a folder containing a larger amount of document information matching an input search condition; and
notifying the folder determined at said determining step.
